(19) United States
(12) Patent Application Publication
(10) Pub. No.: US 2006/0227438 A1
(43) Pub. Date: Oct. 12, 2006

(54) Tabletop wind chime

(76) Inventor: Hsien Hsing Wang, Macau (CN)

Correspondence Address: MORGAN & FINNEGAN, L.L.P., 3 World Financial Center, New York, NY, 10281-2101, US

(21) Appl. No.: 11/349,294

(22) Filed: Feb. 6, 2006

(30) Foreign Application Priority Data
Feb. 6, 2005 (CN) 200520000455X
Mar. 15, 2005 (CN) 200520005500.0
Jul. 28, 2005 (CN) 200520114454.8

(51) Int. Cl. G02B 7/182

(52) U.S. Cl. 359/871

(57) ABSTRACT

The present invention relates to a tabletop wind chime which comprises a base, a trunk, and attached sound-making devices that impact with one another to produce a pleasant sound when it is struck, shaken or blown. Branching rod-like features are attached to the trunk and sound-making devices may be attached to the branching rod-like features. The branching rod-like features have different angular shapes to provide more opportunities for a plurality of sound-making devices to collide to achieve a chiming effect with different tones. Furthermore, decorative light emitting devices may be added to increase the beauty of the invention. According to this invention, a wide variety of shapes, colors, themes, and sounds are made possible while it may be unavailable to traditional wind chimes. For example, a desktop wind chime resembling a tree is possible by designing the trunk and rod-like features like a tree with the sound-making devices like leaves or butterflies. In another example, the desktop wind chime is designed to have umbrella-shaped sound-making devices with sound-making beads to impact against each other to produce sounds when it is struck.

### FIELD OF THE INVENTION

The present invention is directed to a wind chime, in particular, it is directed to a desktop wind chime in the form of a tree.

### TECHNICAL BACKGROUND

Traditional wind chimes adopt a hanging structure. To hang a conventional wind chime requires a hanging device, such as a nail or a hook attached to the hanging surface. Thus, to display a conventional wind chime necessitates damage to the hanging surface.

### SUMMARY OF THE INVENTION

The present invention overcomes the drawback of presently available hanging wind chimes and provides a wind chime in a tree-like form so that it can stand on a desktop.

To achieve this purpose, the wind chime according to the present invention is in the shape of a tree with a base, a trunk and branching rod-like features and sound-making devices. The sound-making devices are attached to the rod-like features through flexible connectors so that when the tree is blown by a breeze or shaken by hand, the sound-making devices will impact against each other to make musical tones. The trunk is attached to the base by means of a spring device so that it can wiggle from side to side as well as up and down to enhance the sound making effect.

The present invention can also be configured to provide a tabletop tree-shaped wind chime that can be displayed without a hanging structure and can produce sounds with different effects through the impact of multiple sound-making beads against umbrella-like sound-making devices when the wind chime is struck with a knocking device or when it is shaken with hand.

A detailed description of the preferred embodiment of this invention is provided below with reference to the accompanying drawings.

### BRIEF DESCRIPTION OF THE DRAWINGS

FIG. 1 is a perspective view of an embodiment of this invention whereby the base and the rest of the wind chime are shown prior to assembly.

FIG. 2 is a perspective view of a second embodiment of this invention whereby the base, the first flexible connecting device between the base and the trunk, the trunk, the second connecting devices, the rod-like features and the sound-making devices are shown prior to assembly.

FIG. 3 is a perspective view of a third embodiment of this invention prior to assembly.

FIG. 4 is a perspective view of a fourth embodiment of this invention prior to assembly.

FIG. 5 is a perspective view of a fifth embodiment of this invention with a knocking device.

FIG. 6 is a sectional view of a fifth embodiment of this invention.

### DETAILED DESCRIPTION OF PREFERRED EMBODIMENT

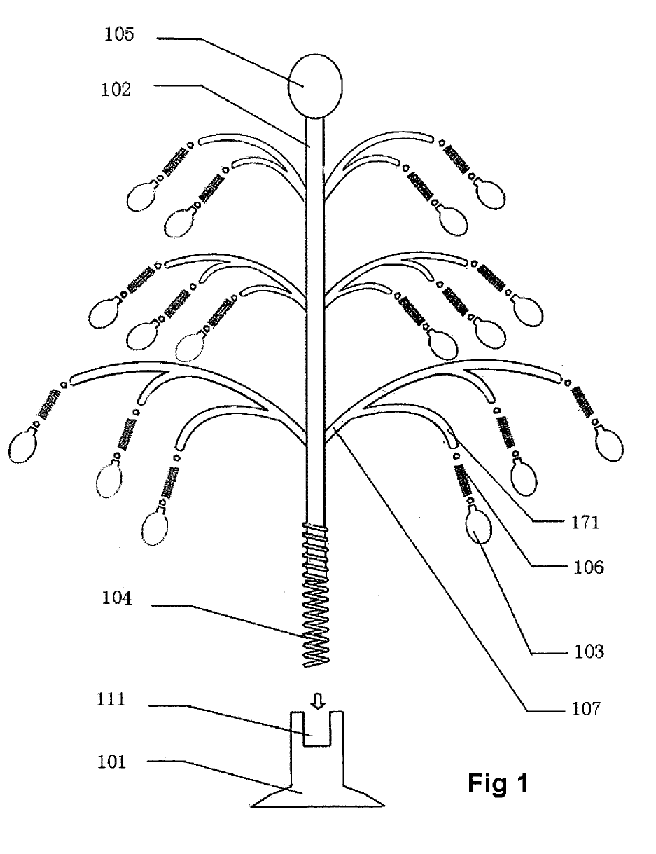

FIG. 1 is a perspective view of the structure of a preferred embodiment of the wind chime in the form of a tree. The invention includes a base 101, a trunk 102, a plurality of leaf-shaped sound making devices 103, a plurality of rod-like features 107, a first flexible connector 104 in the form of a spring, and a top piece 105 atop the tree, a plurality of second flexible connectors 106 for connecting leaf-shaped sound making devices 103 to rod-like features 107. The first flexible connector 104 is preferably a spring. The base 101 is connected to the trunk 102 through the spring 104. The base 101 has an opening at the top, forming a hole 111. The spring 104 can be inserted into the hole 111. As indicated in the embodiment shown in FIG. 1, the diameter of the trunk 102 is slightly less than that of the cylindrical opening formed by the spring 104, so the trunk 102 can be connected to the spring 104 by inserting its bottom part into the cylindrical opening of the spring 104. However, an artisan may use alternative methods, such as an adhesive, to fulfill the same purpose of attaching the trunk to the spring. The rod-like features 107 are attached to the trunk 102 by either permanently glued on the trunk 102 or through flexible connectors. A plurality of small rod-like features 171 are attached to the rod-like features 107, the number of which is equivalent to the number of sound-making devices 103. The sound-making devices 103 are connected to the small rod-like features 171 through second flexible connectors 106. The sound-making devices 103 are provided with connecting means in the form of an n-shaped dovetail 131 at one end for insertion into the second flexible connectors 106. The connection may be reinforced with an adhesive. The top piece 105 may be in a shape similar to the sound-making devices 103, or may vary in shape and size, or may even be small flashing bulbs. A person of ordinary skill in the art may use other methods, such as the use of adhesive, another set of small flexible connectors, or simply plugging the rod-like features 107 into the trunk 102, to achieve the same function of attaching the rod-like features 107 to the trunk 102 without defeating the purpose of the present invention.

In this preferred embodiment, the base is of sufficient size and weight to maintain the tree in an upright position when the device is shaken. The base can be made of different materials, selected from the group consisting of a metal such as lead, a ceramic, clay, plastic, or wood. The base can take different shapes, as desired. The first flexible connector 104 for connecting the base 101 and the trunk 102 provides a flexing action when the tree is shaken so that the sound-making devices will impact against each other to produce sound. The function of the first and second flexible connectors is to enable the trunk and sound-making devices to wiggle from side to side as well as up and down. The second flexible connector 106 for connecting the sound-making device to the rod-like feature is, preferably, more flexible than the first spring-shaped flexible connector 104 that connects the trunk to the base. This higher flexibility of the first or second flexible connectors may be achieved by using wires of different gauges for the spring-like flexible connectors. In this embodiment, for example, the wire gauge of the first flexible connector 104 ranges from 1.6 millimeter to 2.5 millimeter. The wire gauge range of the second flexible connector 106 ranges from 0.3 millimeter to 0.6 millimeter. The number of sound-making devices may vary according to the size of the chime. Preferably, the positioning of the sound-making devices provides balance, and the vertical spaces between the sound-making devices may vary to achieve better sound effects. The sound-making devices are made of a material that, when impacted against each other, will produce a pleasing sound. They can be made of metals, wood, glass, porcelain, ceramic, preferably high-temperature ceramic, which produce a crisp, tickling, pleasant chime when hitting each other. The trunk is preferably made of iron or other materials. If the sound-making devices 103 are made of high-temperature ceramic, they may be molded into different forms in different colors. For example, they may be shaped in animals, flowers, leaves, foods, etc. and optionally painted with various colors. The colors may be applied as glazes on the ceramic and fired at high temperatures.

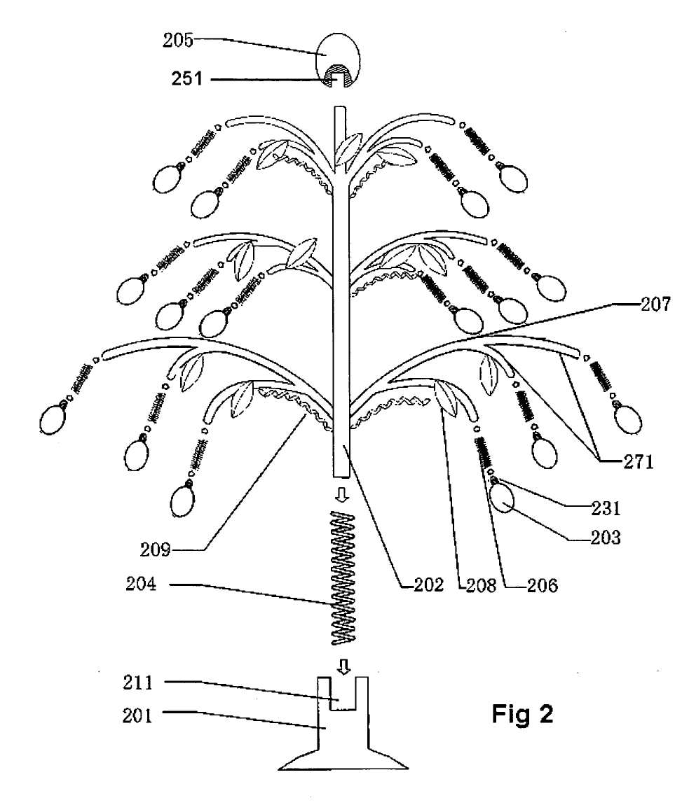

FIG. 2 shows an example of a second embodiment of this invention. According to this embodiment, a wind chime in the form of a tree includes a base 201, a trunk 202, a plurality of leaf-shaped sound-making devices 203, a spring functioning as a flexible connector 204, a top piece on the top of the trunk 205, a plurality of small flexible connectors 206, rod-like features 207, leaf-shaped devices 208 and decorative fringe 209. The base 201 is connected to the trunk 202 with a flexible connector in the form of a spring 204. The gauge range of the flexible connector 204 is 1.6 millimeter to 2.5 millimeter. The base 201 has an opening in the top, forming a hole 211. One end of the spring 204 can be inserted into the hole 211 at the top of the base 201, and the other end of the spring 204 is connected to the trunk 202 by inserting the bottom part of the truck 202 into the cylindrical opening of the spring 204. Branch-like rod-like features 207 are fixed and attached to the trunk 202. One end of the rod-like feature 207 can be inserted into small flexible connectors 206 and be fixed with an adhesive material. There are a number of small rod-like features 271 on the rod-like features 207. A sound-making device 203 forms an n-shaped dovetail 231 at one end. The n-shaped dovetail 231 can be inserted into a small flexible device, in this embodiment, a spring 206, and reinforced with an adhesive material. The gauge range of the spring 206 is 0.3 millimeter to 0.6 millimeter. Leaf-shaped devices 208 are connected and fixed to rod-like features 207 or smaller rod-like features 271. The decorative fringe 209 is attached to the trunk 202. The top piece 205 has an opening at the bottom, forming a hole 251. It is connected and fixed to the top of the trunk 202 through the hole 251.

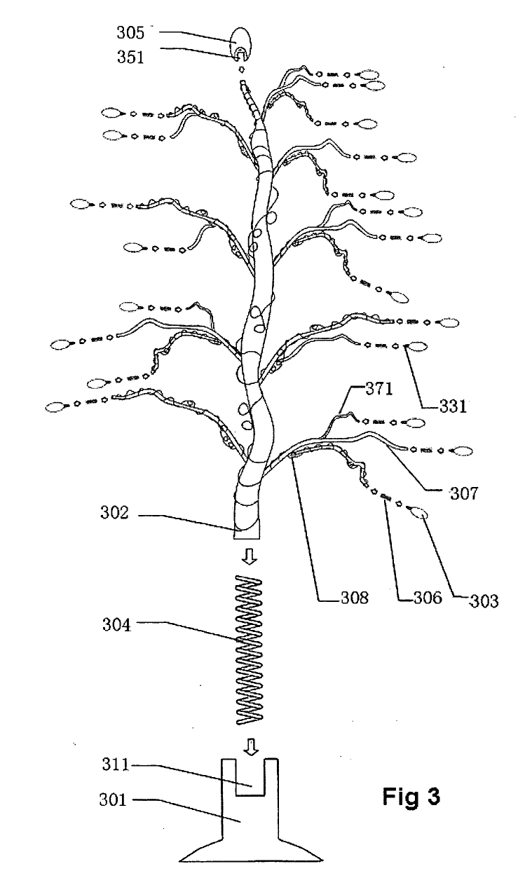

Referring to the example of a third embodiment of this invention in FIG. 3, it includes a base 301, a trunk 302, a plurality of sound-making devices 303, a flexible connector 304, a sound-making device on the top of the trunk 305, a plurality of smaller flexible connectors 306, rod-like features 307 and a tendril 308. The base 301 is connected to the trunk 302 through the flexible connector 304. The gauge of the wire for the flexible connector 304 ranges from 1.6 millimeter to 2.5 millimeter. The base 301 has an opening at the top, forming a hole 311. The flexible connector 304 can be inserted into the base 301 through the hole 311. The trunk 302 is attached to the flexible connector 304 by inserting the bottom part of the trunk 302 into the cylindrical opening of the spring 304. The trunk 302 is curve-shaped with its cross sections varying in different parts. Branching rod-like features 307 are fixed and attached to the trunk 302. The shapes of the rod-like features 307, which are similar to that of the trunk 302, are also curving and vary in cross sections in different parts. The end of a rod-like feature 307 can be inserted into a small flexible connector 306 and stuck and fixed with adhesive material. Small rod-like features 371 are attached to the rod-like features 307. An ∩-shaped dovetail connection means 331 is provided at one end of the sound-making device 303. The dovetail 331 can be inserted into a small flexible connector 306 and, preferably, fixed with adhesive material. The wire gauge of the small flexible connector 306 ranges from 0.3 millimeter to 0.6 millimeter. Tendril-like feature 308 is wiring wound along the trunk 302 and the rod-like features 307 for decoration purpose or connecting to light emitting bulbs. The wiring can be plugged to a power source. The sound-making device on the top of the trunk 305 has an opening at the bottom, forming a hole 351 for connecting and fixing to the top of the trunk 302.

The curving shape and varying cross sections of the trunk and rod-like features in the embodiment of this invention alters the angles for which the sound-making devices 303 strike each other and therefore produce more pleasant sounds. The introduction of light emitting bulbs adds beauty to the chime.

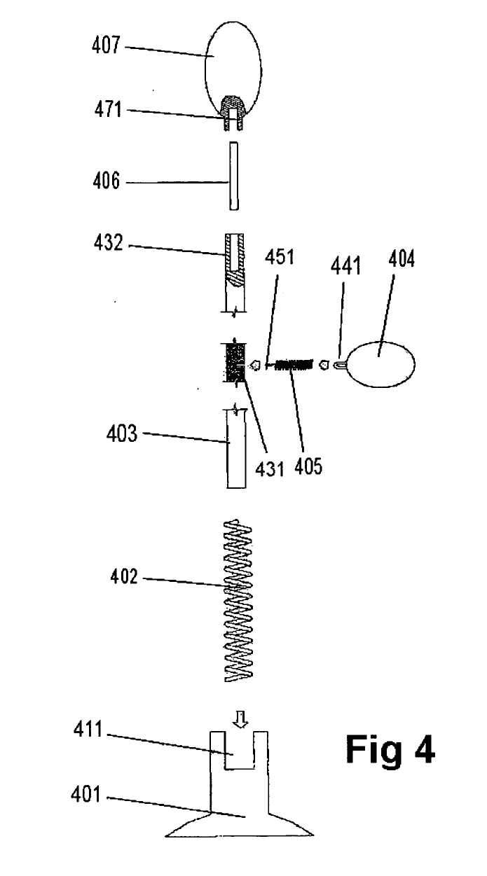

FIG. 4 shows an example of a fourth embodiment of this invention. According to this embodiment, a wind chime in the form of a tree includes a base 401, a flexible connector in form of a spring 402, a trunk 403, a plurality of leaf-shaped sound-making devices 404, a plurality of small flexible connectors 405, a connecting rod 406, and a top piece 407 on the top of the trunk. The base 401 is connected to the trunk 403 through the spring 402. A hole 411 is formed at the top of the base 401, and allows the spring 402 to be inserted. The trunk 403 is attached to the spring 402, and forms many small holes 431 on the surface. At one end a small flexible connector 405 forms a small elongated projecting part 451 that enables the small flexible connector 405 to be plugged into a small hole 431 in the trunk 403. The leaf-shaped sound-making device 404 forms an ∩-shaped dovetails 441 at one end, which is then plugged into the small flexible connector 405 and reinforced with adhesive. The other end of the trunk 403 that is not connected to the spring 402 forms a hole 432 for a connecting rod 406 to plug in. The other end of the connecting rod 406 is plugged into a hole 471 formed at the bottom of the top piece 407. The top piece 407 may be in a shape similar to the sound-making devices 404, or may vary in shape and size, or may even be small flashing bulbs.

In this preferred embodiment, the base 401 is of sufficient size and weight to maintain the tree in an upright position when the device is shaken. The base 401 is made up of different materials, and can take different shapes, as desired. The small flexible connectors 405 may be made up of devices other than spring to achieve the same function, and preferably are made up of springs that consist of filament with small diameter and have low rigidity. The flexible connector 402 preferably is made of a spring that consists of filament with big diameter and has high rigidity. The function of both flexible connectors is to enable the trunk and sound-making devices to wiggle from side to side as well as up and down. In this embodiment, for example, the wire gauge of the spring 402 ranges from 1.6 millimeter to 2.5 millimeter. The wire gauge of the flexible connector 405 ranges from 0.3 millimeter to 0.6 millimeter. The number of sound-making devices may vary according to the size of the chime. Preferably, the positioning of the sound-making devices provides balance, and the vertical spaces between the sound-making devices may vary to achieve better sound effects. The sound-making devices 404 are also preferably made of high-temperature ceramic, which produce a crisp, tickling, pleasant chime when hitting each other. The trunk 403 is made of wood, bamboo or other materials. The sound-making devices 404 are made of high-temperature ceramic, they may be molded into different forms in different colors, such as in the form of animals, flowers, leaves, foods, etc. and optionally provided with various colors as desired. The colors may be in the form of glazes and fired at high temperatures. The tree-shaped wind chime of this invention adopts a “snap-together” structure, meaning it may be successfully assembled without additional connectors or adhesives. However, adhesives may be used to reinforce the strength of the connections. The height of the trunk 403, the shape and size of the sound-making devices 404 can be adjusted as desired.

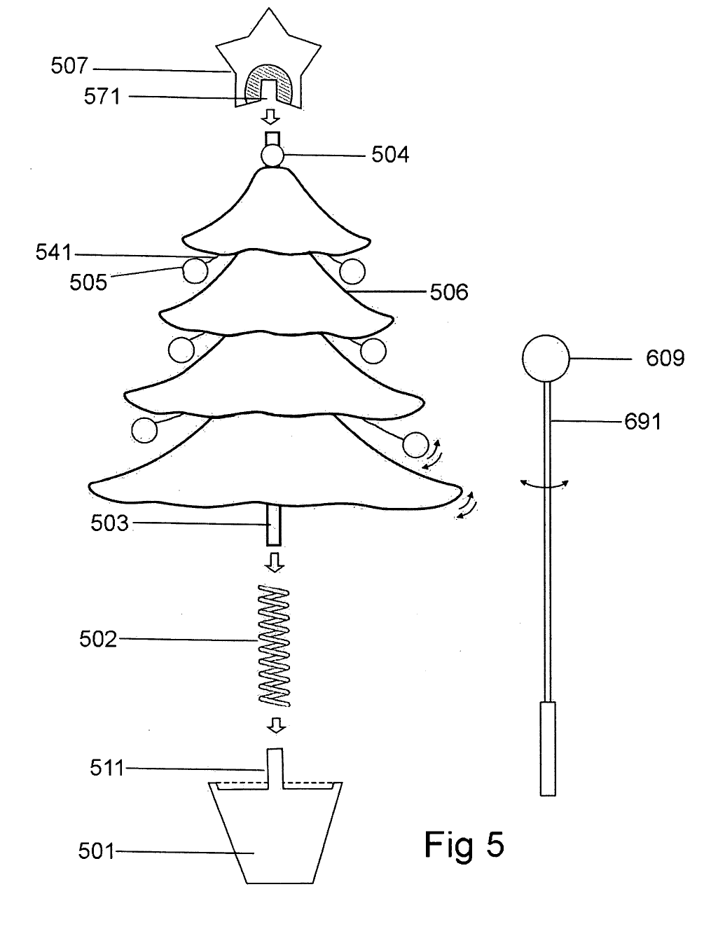

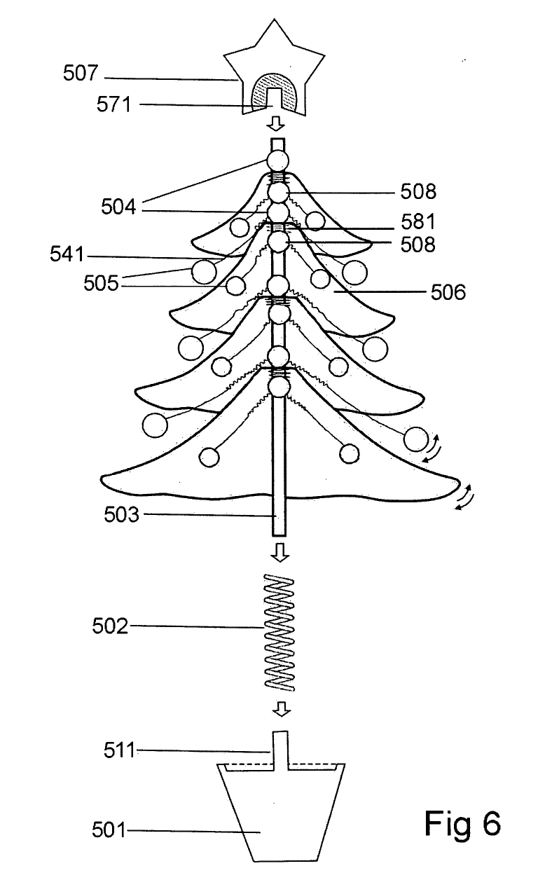

FIG. 5 is a perspective view of a fifth embodiment of this invention with a knocking device. FIG. 6 is a sectional view of a fifth embodiment of this invention. As shown in FIGS. 5-6, this tabletop tree-shaped wind chime includes a base 501, a connecting element 511, a first flexible connector 502, a trunk 503, a plurality beads 504 and 508, second flexible connectors 581, third flexible connectors 541, at least one sound-making bead 505, at least one high-temperature ceramic piece 506, a decorative piece 507 on the top. The beads 504 and 508 may be made of wood. The flexible connectors 502, 581 and 541 are preferably in the form of springs. This embodiment also comprises a knocking device with a hammerhead 609, and an elastic stalk 691 preferably made of bamboo. The high-temperature ceramic piece 506 is preferably in the shape of an umbrella.

The base 501 forms an upward protruding connecting element 511 at the top. The connecting element 511 and the bottom of the trunk 503 are of an appropriate size so that they can be connected to the spring 502 by plugging them into the inner longitudinal opening formed by the spring 502. When the wind chime is struck with a knocking device or when it is shaken with hand, the wind chime will wiggle from side to side and up and down to enhance the sound making effect. One pair of the beads 504 and 508 and a second flexible connector 581 are used to support the high-temperature ceramic piece 506 on the trunk 3 and help to enhance the sound making effect. The beads 508 and 504 are fixed to the trunk. A second flexible connector 581 is placed in between the beads 504 and 508 encircling the trunk 503. The second flexible connector 581 has a diameter bigger than the diameter of the trunk so that the trunk can be encircled within the second flexible connector 581. The ceramic piece 506 has an aperture on the top. The aperture has a diameter bigger than the diameter of the trunk 503, but smaller than the diameter of the second connector 581, so that the ceramic piece 506 can be placed to encircle the trunk and supported by the second connector 506. The ceramic piece 506 is placed in between the bead 504 and the spring 581, so that when the wind chime is wiggled or shaken, the ceramic piece 506 can move up and down or from side to side following the movement of the second flexible connector 581 to generate various sounds. The beads 504 and 508 can be glued to the trunk 503, by way of example. Sound-making beads 505 are connected to the beads 504 and 508 through third flexible connectors 541. The third flexible connectors 541 can be glued to 504, 508 and 505, by way of example. Any other manner of connection or affixation may be used. The decorative piece 507 has an opening 571. One end of the trunk 503 is connected to the decorative piece 507 by inserting the trunk 503 into the opening 571.

The present invention also includes a knocking device designed to work with the wind chime. The knocking device is made up of a hammerhead 609 and an elastic hammer stalk 691. The hammerhead 609 is attached to an elastic piece 691 with an adhesive, and can be used to strike the ceramic piece 506 to produce various sounds. The elastic piece 691 can be made of bamboo, by way of example.

In the preferred embodiment, base 501 is designed to keep the wind chime stable, and is of sufficient weight to prevent the wind chime from falling over when it is touched, shaken or knocked. The base 501 can be made of different materials, such as wood, metal or plastic with different shapes. The first flexible connector 502 can be a device other than a spring, provided that it achieves the same functionality. The first flexible connector 502 is preferably made from spring with high rigidity and big diameter, for example, springs of gauge 0.3 mm to 1.0 mm. The third flexible connectors 541 are preferably made from springs with high elasticity, for example, springs of gauge 0.3 mm to 0.6 mm. The total number of sound-making beads 505 or ceramic pieces 506 may vary, and may be made up from different materials, according to the size of the wind chime and sound effect to achieve. These beads 504 may be affixed in different spacing on the trunk 503 to achieve better sound effect. Trunk 503 can be made of iron, wood, bamboo or other materials.

To enhance its durability, an adhesive may be introduced to reinforce all connections. The height of the trunk, the sizes, shapes and colors of the ceramic pieces pieces, beads, the sound-making beads, and the vertical spacing where ceramic pieces are placed can be adjusted as desired.

The tree-shaped wind chime of this invention adopts a “snap-together” structure, meaning it may be successfully assembled without additional connectors or adhesives. However, adhesives may be used to reinforce the strength of the connections. The height of the trunk, the shape and size of the sound-making devices, including the sound-making beads and ceramic pieces, can be adjusted as desired.

What is claimed is:

1. A desktop wind chime, comprising:
a base;
a first flexible connector;
a trunk connected to the base through the first flexible connector;
a plurality of branching rod-like features attached to the trunk;
a plurality of second flexible connectors for connecting at least one sound-making devices to each of the branching rod-like features.

2. The desktop wind chime according to claim 1, wherein the sound-making device forms a dovetail at one end to be connected to the second flexible connector.

3. The desktop wind chime according to claim 1, further comprising decorative fringe attached to the trunk.

4. The desktop wind chime according to claim 1, further comprising decorative leaves attached to the rod-like features.

5. The desktop wind chime according to claim 1, further comprising tendril attached to the trunk.

6. The desktop wind chime according to claim 2, wherein the dovetail at one end of the sound-making device is in an n-shape.

7. The desktop wind chime according to claim 1 further comprising a decorative piece, the decorative piece being connected at the top of the trunk.

8. The desktop wind chime according to claim 7 wherein the decorative piece is in the shape of a leaf.

9. The desktop wind chime according to claim 1, wherein the first flexible connector is a spring.

10. The desktop wind chime according to claim 1, wherein the second flexible connector is a spring.

11. The desktop wind chime according to claim 7, wherein the decorative piece is connected to the trunk through a rod.

12. The desktop wind chime according to claim 8, wherein the leaf-shaped decorative piece is connected to the trunk through a rod.

13. The desktop wind chime according to claim 1, wherein the sound-making device are made of high-temperature ceramic.

14. A desktop wind chime, comprising:
a base;
a first flexible connector;
a trunk connected to the base through the first flexible connector;
a plurality of branching rod-like features attached to the trunk;
a plurality of sub-rod-like feature attached to each of a number of the branching rod-like features;
a plurality of second flexible connectors connecting at least one sound-making device to each of a number of the sub-rod-like features.

15. The desktop wind chime according to claim 14, wherein the sound-making device forms a dovetail at one end to be connected to the second flexible connector.

16. The desktop wind chime according to claim 14, further comprising decorative fringe attached to the trunk.

17. The desktop wind chime according to claim 14, further comprising decorative leaves attached to the rod-like features.

18. The desktop wind chime according to claim 14, further comprising tendril attached to the trunk.

19. The desktop wind chime according to claim 15, wherein the dovetail at one end of the sound-making device is in an ∩-shape.

20. The desktop wind chime according to claim 14 further comprising a decorative piece, the decorative piece being connected at the top of the trunk.

21. The desktop wind chime according to claim 14 further comprising a leaf, the leaf being connected at the top of the trunk.

22. The desktop wind chime according to claim 14, wherein the first flexible connector is a spring.

23. The desktop wind chime according to claim 14, wherein the second flexible connector is a spring.

24. The desktop wind chime according to claim 20, wherein the decorative piece is connected to the trunk through a rod.

25. The desktop wind chime according to claim 21, wherein the decorative piece is connected to the trunk through a rod.

26. The desktop wind chime according to claim 14, wherein the sound-making devices are made of high-temperature ceramic.

27. A desktop wind chime, comprising:
a base;
a trunk;
a first flexible connector connecting the trunk with the base a plurality of sound-making devices forming elongated projecting n-shaped dovetails at one end;
a plurality of second flexible connectors connecting the plurality of sound-making devices with the trunk by inserting the n-shaped dovetails on the sound-making device to each flexible connector and then plugging the flexible connectors to the trunk.

28. The desktop wind chime according to claim 27, wherein a decorative piece is placed at the top of the trunk.

29. The desktop wind chime according to claim 27, wherein the decorative piece is a in a shape of a leaf.

30. The desktop wind chime according to claim 27, wherein the flexible connectors are springs.

31. The desktop wind chime according to claim 28 furthering comprising a rod, the rod connecting the decorative piece to the top of the trunk.

32. The desktop wind chime according to claim 29 furthering comprising a rod, the rod connecting the leaf-shaped piece to the top of the trunk.

33. The desktop wind chime according to claim 27, wherein the sound-making devices are made of high-temperature ceramic.

34. The desktop wind chime according to claim 28, wherein the sound-making devices are made of high-temperature ceramic.

35. The desktop wind chime according to claim 29, wherein the leaf-shaped devices are made of high-temperature ceramic.

36. A tabletop tree-shaped wind chime, comprising:
a base;
a trunk;
a first flexible connector connecting the trunk to the base;
a plurality of second flexible connectors comprising at least one upper bead and a lower bead with the upper bead being affixed to the trunk, said second flexible connectors encircling the trunk;
at least one sound making piece with a central aperture attached to each second flexible connector encircling the trunk; the sound-making bead being connected with the upper bead and the lower bead through a third flexible connector; and
a decorative piece mounted on the top of the trunk.

37. The tabletop tree-shaped wind chime according to claim 36, wherein the sound making piece is made of high-temperature ceramic.

38. The tabletop tree-shaped wind chime according to claim 36, wherein the sound making piece is in the shape of an umbrella.

39. The tabletop tree-shaped wind chime according to claim 36, wherein the upper bead and the lower bead are made of wood.

40. The tabletop tree-shaped wind chime according to claim 36, wherein the sound-making bead is made of glass or high-temperature ceramic.

41. The tabletop tree-shaped wind chime according to claim 36, wherein the top piece has an opening at the bottom, whereby the top piece is connected to the trunk through the opening at the bottom.

42. The tabletop tree-shaped wind chime according to claim 36 further comprising a knocking device, wherein the knocking device comprising a hammerhead and an elastic hammer stalk.

43. The tabletop tree-shaped wind chime according to claim 42, wherein the elastic hammer stalk is made from bamboo.
